(19) United States
(12) Patent Application Publication
(10) Pub. No.: US 2003/0163814 A1
(43) Pub. Date: Aug. 28, 2003

(54) Portable remote terminal apparatus and method for displaying electronic program guide

(75) Inventor: Yutaka Hayakawa, Takatsuki-shi (JP)

Correspondence Address: MERCHANT & GOULD PC, P.O. BOX 2903, MINNEAPOLIS, MN, 55402-0903, US

(73) Assignee: MATSUSHITA ELECTRIC INDUSTRIAL CO., LTD., Kadoma-shi (JP)

(21) Appl. No.: 10/374,399

(22) Filed: Feb. 25, 2003

(30) Foreign Application Priority Data
Feb. 27, 2002 (JP) 2002-051199

(51) Int. Cl. G06F 3/00; H04N 5/445; G06F 13/00; H04N 5/44

(52) U.S. Cl. 725/45; 348/734

(57) ABSTRACT

A portable remote terminal apparatus that can display a readily legible program guide even when the apparatus has only a small screen and a method for displaying an electronic program guide that can display a readily legible program guide on a small screen are provided. The portable remote terminal apparatus is constituted by a receiver portion for receiving program guide information, a storing portion for storing simplified symbols that represent in a simplified manner at least one of kinds of a genre, a channel and an airtime of a program, a detecting portion for detecting necessary information from the program guide information, a constructing portion for selecting the simplified symbols corresponding to the genre, the airtime and the channel of the program included in the detected information and arranging the simplified symbols that have been selected, thus constructing the program guide table, and a displaying portion for displaying the program guide table that has been constructed.

### BACKGROUND OF THE INVENTION

1. Field of the Invention

The present invention relates to a portable remote terminal having a function of a digital television (in the following, referred to as “digital TV”) and further having an electronic program guide function, and a method for displaying an electronic program guide.

2. Description of Related Art

Digital TV receivers for BS digital broadcasting and CS digital broadcasting come standard with an electronic program guide function. Such an electronic program guide function has been developed for use with a large screen, such that two-dimensional geometric graphics are displayed on the screen. When digital terrestrial broadcasting begins and receivers designed exclusively for this broadcasting come into wide use in the future, the electronic program guide function is expected to become standard also in these receivers.

The digital TV receivers for the digital terrestrial broadcasting are different from the current digital TV receivers for the BS digital broadcasting and CS digital broadcasting in that they do not need any stationary parabolic antennas. Accordingly, it is anticipated that a system combining the digital TV receiver for the digital terrestrial broadcasting and a portable remote terminal such as a cellular phone or a car navigation system will be developed.

However, since the conventional electronic program guides are designed for use with a large screen as mentioned above and for displaying rather detailed program information such as a summary of program contents, a large number of characters and the like are to be displayed on the screen. Accordingly, when attempting to achieve a program guide function similar to that for the digital TV receivers in a portable remote terminal having only a small screen, the displayed characters constituting the program guide become smaller than those displayed in the digital TV receivers. In such cases, some people find it difficult to identify what is displayed on the screen and to read out information since a minimum size for legible characters varies depending on individuals.

### SUMMARY OF THE INVENTION

It is an object of the present invention to provide a portable remote terminal apparatus that can display a readily legible program guide even when the apparatus has only a small screen, and a method for displaying an electronic program guide that can display a readily legible program guide on a small screen.

In order to achieve the above-mentioned object, a portable remote terminal apparatus according to the present invention is a portable remote terminal apparatus for receiving a program guide information that includes at least a title information, a genre information, an airtime information and a channel information of a program and displaying a program guide table. The portable remote terminal apparatus includes a receiver portion for receiving the program guide information, a storing portion for storing symbols that represent in a simplified manner at least one of kinds of a genre, a channel and an airtime of the program, a detecting portion for detecting the genre information, the airtime information and the channel information of the program from the program guide information, a constructing portion for selecting the symbols corresponding to the genre, the airtime and the channel of the program included in the genre information, the airtime information and the channel information of the program that have been detected and arranging the symbols that have been selected, thus constructing the program guide table, and a displaying portion for displaying the program guide table that has been constructed.

Preferably, the above-described portable remote terminal apparatus according to the present invention further includes an input portion for accepting an input of the information from a user. In this case, the symbols that represent in a simplified manner the at least one of kinds of the genre, the channel and the airtime of the program can be set by the user, the input portion can accept the input of the symbols that have been set by the user, and the storing portion can store the symbols that have been input.

Also, the input portion can accept the input of a minimum size for the symbols constituting the program guide table, and the displaying portion can display the program guide table constituted by the symbols that are at least as large as the minimum size.

Furthermore, the input portion further can accept the input of a program that is selected by the user based on the program guide table, the detecting portion can detect from the program guide information stored in the storing portion the title information, the genre information, the airtime information and the channel information of the program selected by the user, and the displaying portion can display a title, a genre, an airtime and a channel of the program based on the detected information.

Also, in the above-described portable remote terminal apparatus according to the present invention, the displaying portion also can display the title, the genre, the airtime and the channel of the program and an entirety or a part of the program guide table on a single screen.

Next, in order to achieve the above-mentioned object, a method for displaying an electronic program guide according to the present invention is a method of receiving a program guide information that includes at least a title information, a genre information, an airtime information and a channel information of a program and displaying a program guide table. The method includes (a) setting symbols that represent in a simplified manner at least one of kinds of a genre, a channel and an airtime of the program, (b) receiving the program guide information, (c) detecting the genre information, the airtime information and the channel information of the program from the program guide information, (d) selecting the symbols corresponding to the genre, the airtime and the channel of the program included in the genre information, the airtime information and the channel information of the program that have been detected and arranging the symbols that have been selected, thus constructing the program guide table, and (e) displaying the program guide table that has been constructed.

In the above-described method for displaying an electronic program guide according to the present invention, in the (a) setting, a minimum size for the symbols constituting the program guide table can be set, and in the (e) displaying, the program guide table constituted by the symbols that are at least as large as the minimum size can be displayed.

In a preferable aspect of the present invention, the above-described method for displaying an electronic program guide according to the present invention further includes (f) selecting at least one program based on the program guide table, (g) detecting from the program guide information the title information, the genre information, the airtime information and the channel information of the program that has been selected, and (h) displaying a title, a genre, an airtime and a channel of the program based on the detected information.

In the above aspect, in the (h) displaying, the title, the genre, the airtime and the channel of the program and an entirety or a part of the program guide table also may be displayed together on a single screen.

### BRIEF DESCRIPTION OF THE DRAWINGS

FIG. 1 is a block diagram showing a schematic configuration of a portable remote terminal apparatus according to an embodiment of the present invention.

FIG. 2A illustrates exemplary program guide information and its operation, and

FIG. 2B illustrates an example of converting the program guide information into symbols.

FIG. 3 is a flowchart showing a method for displaying an electronic program guide and an operation of the portable remote terminal apparatus shown in FIG. 1 according to an embodiment of the present invention.

FIG. 4 illustrates an exemplary screen that is to be displayed in a displaying portion when a user sets symbols for representing in a simplified manner kinds of a genre, a channel and an airtime of a program.

FIG. 5 illustrates an example of a program guide table and detailed program information that are to be displayed in the displaying portion (display example 1).

FIG. 6 illustrates an example of the program guide table and the detailed program information that are to be displayed in the displaying portion (display example 2).

FIG. 7 illustrates an example of the program guide table and the detailed program information that are to be displayed in the displaying portion (display example 3).

FIG. 8 illustrates an example of the program guide table and the detailed program information that are to be displayed in the displaying portion (display example 4).

FIG. 9 illustrates an example of the program guide table and the detailed program information that are to be displayed in the displaying portion (display example 5).

### DESCRIPTION OF THE PREFERRED EMBODIMENTS

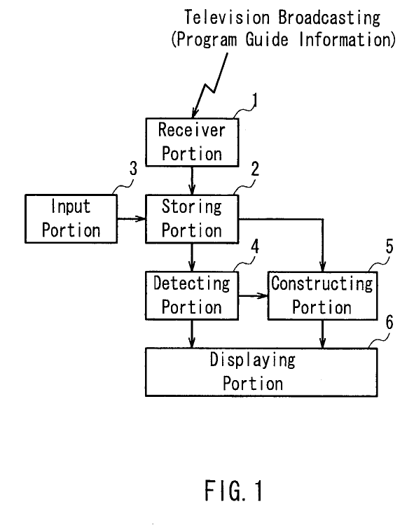

The following is a description of a portable remote terminal apparatus and a method for displaying an electronic program guide according to an embodiment of the present invention, with reference to FIGS. 1 to 9.

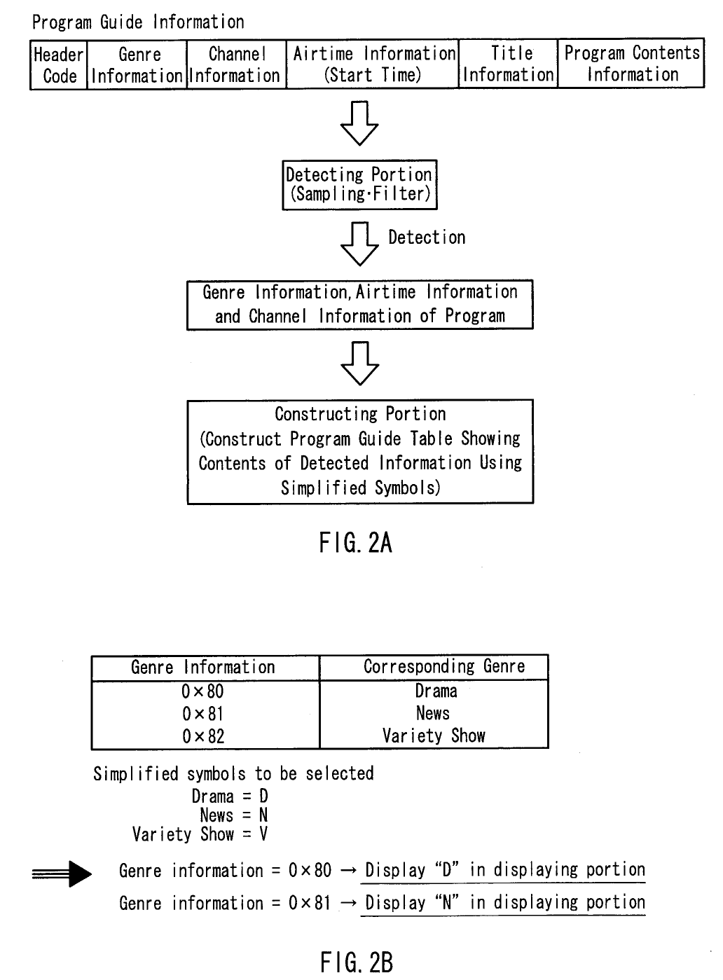

First, a configuration of the portable remote terminal apparatus according to the present embodiment will be described using FIGS. 1 and 2. FIG. 1 is a block diagram showing a schematic configuration of the portable remote terminal apparatus according to the present embodiment. FIG. 2A illustrates exemplary program guide information and its operation, and FIG. 2B illustrates an example of converting the program guide information into symbols.

As shown in FIG. 1, the portable remote terminal apparatus according to the present embodiment includes a receiver portion 1, a storing portion 2, an input portion 3, a detecting portion 4, a constructing portion 5 and a displaying portion 6. In the present embodiment, the portable remote terminal apparatus is a cellular phone provided with a function of a digital TV receiver. However, in the present invention, the portable remote terminal apparatus is not limited to a cellular phone but may be a car navigation system, a hand-held game machine or the like as long as it is portable and has a display screen.

The receiver portion 1 receives program guide information transmitted with television signals. In the present embodiment, as shown in FIG. 2A, the program guide information includes a header code, and genre information, channel information, airtime information, title information and program contents information on a plurality of programs. In the present invention, the program guide information also may include other information. In the present embodiment, the television signals are digital terrestrial signals. Thus, the program guide information includes program guides of various broadcasting stations.

The input portion 3 accepts inputs from a user. Since a user sets symbols representing in a simplified manner kinds of a genre, a channel and an airtime of a program (in the following, simply referred to as “simplified symbols”) in the present embodiment, the input portion 3 accepts inputs of information regarding these simplified symbols. In addition, the input portion 3 also accepts inputs of a minimum size for the simplified symbols set by a user and of a program selected by a user.

In the present invention, the “simplified symbols” refer to symbols that display a genre, a channel and an airtime of a program. In the present invention, since a program guide table constructed with these simplified symbols is displayed as will be described below, a user can find the genre, channel and airtime of the program. In other words, according to the present invention, even with a small display screen, information as much as that in a program guide of a digital TV receiver can be made available to a user. Examples of the “simplified symbols” may include characters, signs, graphics, geometries, pictorial symbols, icons and a combination thereof.

The storing portion 2 stores the received program guide information and the information input by a user. Since a user sets the simplified symbols in the present embodiment as mentioned above, the simplified symbols set by the user are stored in the storing portion 2. Incidentally, in the present invention, a manufacturer may set the simplified symbols in advance during a manufacturing stage of the portable remote terminal apparatus, and these set simplified symbols may be stored in the storing portion 2 in advance. Furthermore, the user also can change the simplified symbols that have been set by the manufacturer.

The detecting portion 4 detects required information from the program guide information stored in the storing portion 2. In the case of constructing a program guide table for example, genre information, airtime information and channel information of a plurality of programs are detected as shown in FIG. 2A.

The constructing portion 5 selects simplified symbols corresponding to genre, airtime and channel that are included in the detected genre information, airtime information and channel information of the programs, from the simplified symbols that have been stored in advance in the storing portion 2. For instance, in the example shown in FIG. 2B, the genre information includes genres of drama, news and variety show, so “D” representing “drama”, “N” representing “news” and “V” representing “variety show” are selected. Further, the constructing portion 5 arranges the selected symbols so as to construct a program guide table.

The displaying portion 6 displays the program guide table that has been constructed in the constructing portion 5 and other information that is requested by a user. Moreover, since the symbols are set suitably by a user in the present embodiment as described above, the displaying portion 6 also displays a setting screen and the like for setting these symbols.

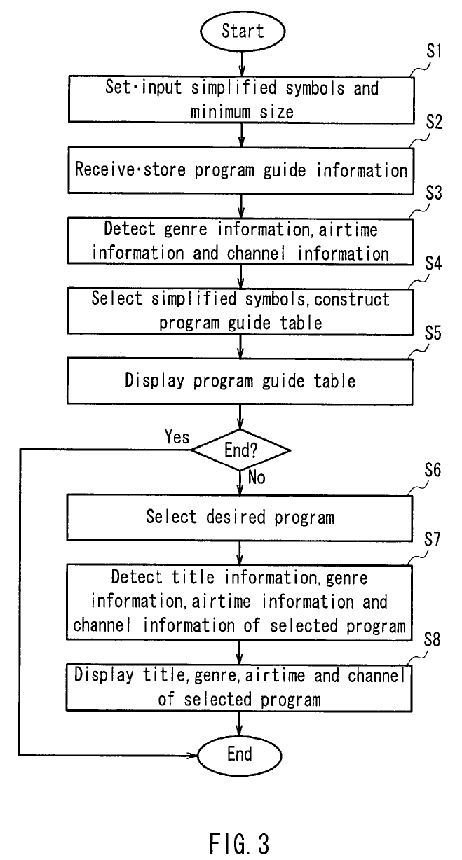

Next, a method for displaying an electronic program guide and an operation of the portable remote terminal apparatus according to the present embodiment will be described using FIGS. 3 to 9. In the present embodiment, the method for displaying an electronic program guide is carried out by operating the portable remote terminal apparatus shown in FIG. 1. The following description refers to FIG. 1 as necessary.

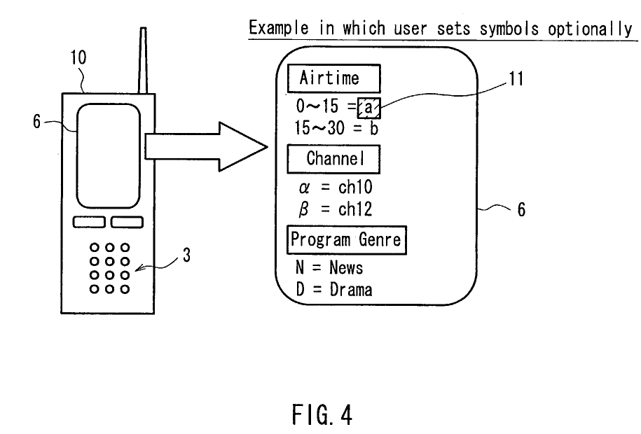

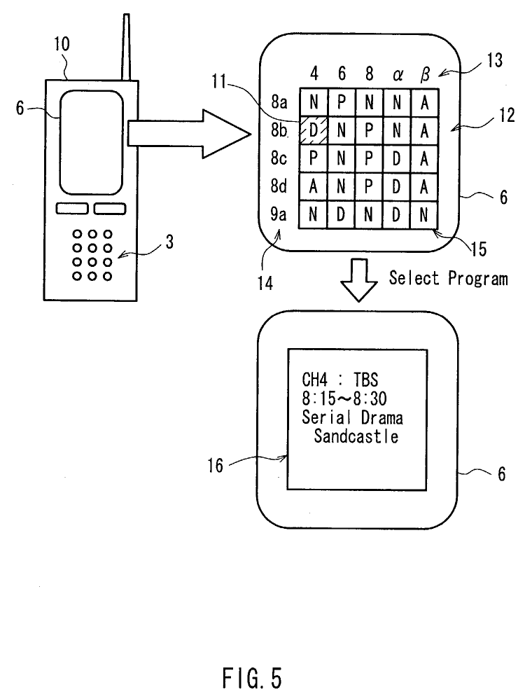

FIG. 3 is a flowchart showing the method for displaying an electronic program guide and the operation of the portable remote terminal apparatus shown in FIG. 1 according to the present embodiment. FIG. 4 illustrates an exemplary screen that is to be displayed in the displaying portion when a user sets symbols for representing in a simplified manner kinds of a genre, a channel and an airtime of a program. FIGS. 5 to 9 illustrate examples of a program guide table and detailed program information that are to be displayed in the displaying portion, and correspond to display examples 1 to 5, respectively.

First, as shown in FIG. 3, a user sets and inputs simplified symbols (Step S1). At the same time, the input portion 3 accepts the input of the set simplified symbols. These set simplified symbols constitute a program guide table, which will be described later. Also, as shown in FIG. 4, a setting screen is displayed in the displaying portion 6 of a portable remote terminal apparatus 10. A user sets and inputs the simplified symbols according to this setting screen. More specifically, the simplified symbols are set and input as follows. The user selects with a cursor 11 a setting item displayed on the setting screen and inputs the symbol that he/she has selected with a key provided in the input portion 3.

In the present embodiment, the kinds of the airtime are shown by time frames of each quarter of an hour. For example, the simplified symbols are set such that a time frame of the first quarter of an hour is expressed by “a”, that of the second quarter of an hour is expressed by “b”, that of the third quarter of an hour is expressed by “c”, and that of the fourth quarter of an hour is expressed by “d” (FIG. 4 shows “a” and “b” alone).

Further, the kinds of the channel mostly are shown by numerals. Although this might not be necessary, only channels with two digits or more such as ch10 and ch12 are set as “α” and “β” for the purpose of saving display areas when the channels have a number with at least two digits. The program genres are set such that “N” represents “news”, “D” represents “drama”, “P” represents “program guide”, “A” represents “animated cartoon”, and “V” represents “variety show” (see FIG. 2B) (FIG. 4 shows “N” and “D” alone).

In the present embodiment, in Step S1, a user also sets and inputs a minimum size for the simplified symbols to be displayed in the displaying portion, and the input portion 3 accepts the input of this minimum size for the simplified symbols. The minimum size is set and input before the simplified symbols are set and input, so that the setting of the minimum size already is reflected in the setting screen shown in FIG. 4. Thus, the displayed characters and the like constituting the setting screen also are at least as large as that minimum size, thereby preventing the setting screen from becoming less legible for a user.

The simplified symbols and the minimum size that have been set by the user in Step S1 are accepted by the input portion 3 and then stored in the storing portion 2.

Then, the receiver portion 1 receives program guide information (see FIG. 2B), and the storing portion 2 stores the program guide information that has been received by the receiver portion 1 (Step S2). Subsequently, the detecting portion 4 detects genre information, airtime information and channel information of a plurality of programs from the program guide information stored in the storing portion 2 (Step S3).

Thereafter, the constructing portion 5 selects simplified symbols corresponding to a genre, an airtime and a channel of each program that are included in the respective detected information and arranges the selected simplified symbols, thus constructing a program guide table (Step S4).

After Step S4, the displaying portion 6 displays the program guide table (Step S5). More specifically, a program guide table 12 shown in FIG. 5 is displayed in the displaying portion 6. With columns indicating simplified symbols 13 of the channels and rows indicating simplified symbols 14 of the airtimes, the program guide table 12 is constructed as a matrix of simplified symbols 15 of the genres corresponding to the respective rows and columns.

At the time when the program guide table 12 is displayed, the user may end the program guide. However, in the present embodiment, it is possible to display detailed information of a program selected optionally by the user. In this case, after Step S5, the user inputs the program whose detailed information he/she wants to display based on the program guide table (Step S6). At the same time, the input portion 3 accepts the input of the program selected by the user based on the program guide table. More specifically, the user puts the cursor 11 on the simplified symbol 15 of the genre of the desired program and selects it by a key operation.

After the selection by the user, the detecting portion 4 detects title information, genre information, airtime information and channel information of the program selected by the user from the program guide information stored in the storing portion 2 (Step S7).

Next, based on the title information, the genre information, the airtime information and the channel information of the program that have been detected in Step S7, the displaying portion 6 displays a title, a genre, an airtime and a channel of the program selected by the user, as the detailed information of the program (Step S8). As shown in FIG. 5, detailed information 16 of the program is displayed not with a simplified symbol but with normal characters and numerals. The detailed information 16 also is displayed reflecting the minimum size set by the user.

The portable remote terminal apparatus according to the present embodiment is constituted so that the screen can be scrolled by a key input to the input portion 3 when the entire program guide table 12 or the entire detailed information 16 cannot be displayed at the same time. Furthermore, it also is possible to switch optionally between the displaying of the program guide table 12 and that of the detailed information 16 by a key input.

Although the displayed detailed information 16 of the program does not include contents information of the program (for example, the summary of the contents such as synopses of dramas) in the present embodiment, such information also may be displayed in the present invention. Furthermore, although the present embodiment is directed to the case of switching completely the screens so as to display the detailed information 16 of the program, the present invention is by no means limited to this. For example, the detailed information 16 of the program also may be displayed by a pop-up display on the screen displaying the program guide table 12.

As described above, the portable remote terminal apparatus and the method for displaying a program guide according to the present embodiment make it possible to display the genre, airtime and channel of the program necessary for the program guide by simple symbols that can be understood easily by a user. Thus, even a small screen can convey information needed by the user, so that the user easily can see the flow of overall programs such as “what genre of program is broadcasted on which channel at what time.”

Moreover, since there are fewer symbols that need to be displayed, it is possible to prevent the symbols to be displayed from becoming so small as to be illegible or cause misreadings by a user. In particular, since a user can suitably set the minimum size for the symbols to be used in the program guide table in the present embodiment, an individual difference among users is also addressed.

Furthermore, since the portable remote terminal apparatus and the method for displaying the electronic program guide according to the present invention can provide a user with detailed information of a program, the user can obtain information as much as that in the case of using a TV receiver.

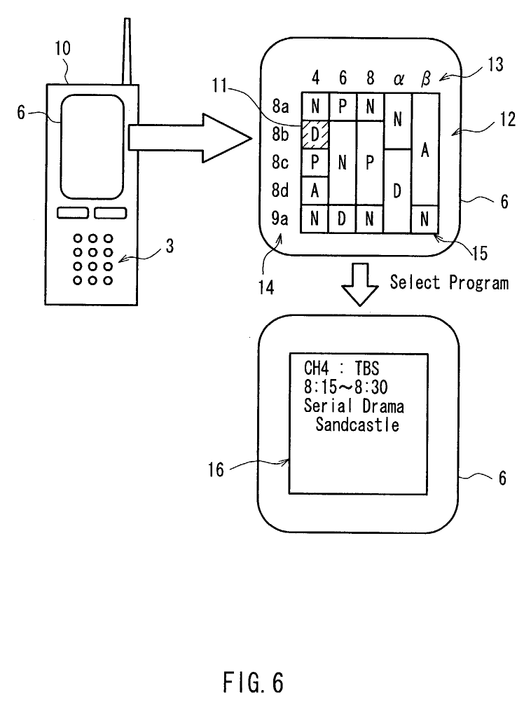

In the display example 1 shown in FIG. 5, the size of cells in the matrix for displaying the simplified symbols 15 of the genre is fixed. Therefore, a program lasting for a plurality of time frames is shown by displaying the same simplified symbols 15 of that genre (“N” in this case) successively in a plurality of matrix cells as in 8b to 8d on ch6, for example. However, in the present invention, how the display portion displays the program guide table 12 and the detailed information 16 is not limited to that in the display example 1 shown in FIG. 5. In the following, the display examples 2 to 5 shown in FIGS. 6 to 9 will be described.

The display example 2 shown in FIG. 6 is an example in which the size of cells in the matrix for displaying the simplified symbols 15 of the genre is not fixed. Unlike the display example 1, the matrix cells for the program lasting for a plurality of time frames (for example, the program of 8b to 8d on ch6) are larger than those for the other programs (for example, the program of 8a on ch6) in the display example 2. Incidentally, as in the display example 1, the program guide table 12 and the detailed information 16 are switched and displayed in the display example 2.

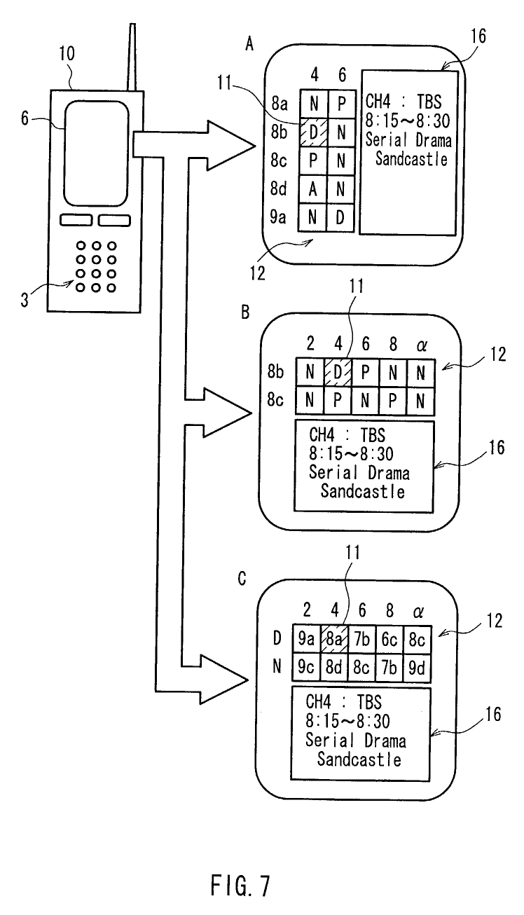

The display example 3 shown in FIG. 7 is an example in which the program guide table 12 and the detailed information 16 are displayed on a single screen, unlike the display examples 1 and 2. Incidentally, as in the display example 1, the size of the matrix cells also is fixed in the display example 3. Further, in the display example 3, there are three different display modes, namely, A, B and C, which can be switched by a key input to the input portion 3.

The display mode A is most suitable for the case where a user values channel information, and the program guide table only for the channels selected by the user is displayed. On the other hand, the display mode B is most suitable for the case where a user values airtime information, and the program guide table only for the airtimes selected by the user is displayed. Further, the display mode C is most suitable for the case where a user values genre information. In the display mode C, unlike the display modes A and B, the simplified symbols of the airtime are displayed in the matrix cells of the program guide table 12, so as to allow the user to tell at a glance when the program that he/she wants to watch will be broadcasted.

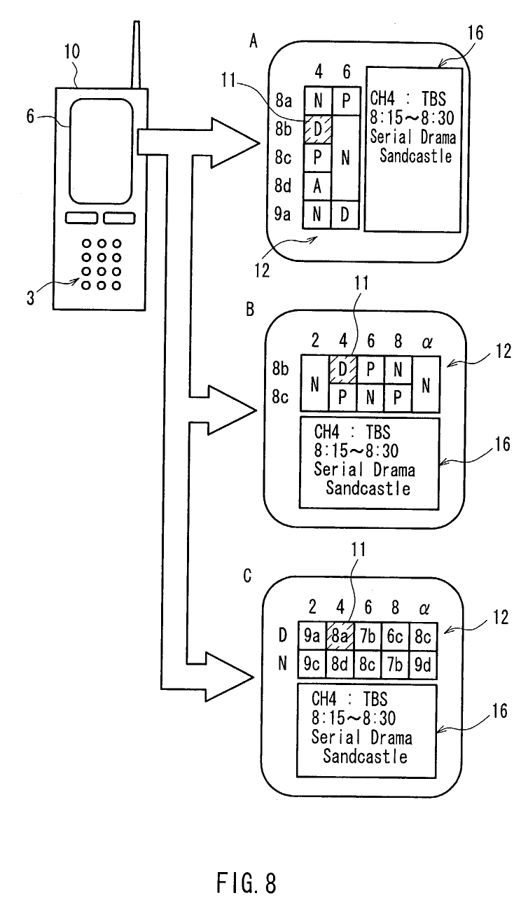

The display example 4 shown in FIG. 8 also is an example in which the program guide table 12 and the detailed information 16 are displayed on a single screen, as in the display example 3. However, unlike the display example 3, the size of the matrix cells is not fixed. Further, in the display example 4, there also are three different display modes, namely, A, B and C, which can be switched by a key input to the input portion 3. The display mode A is most suitable for the case where a user values channel information, the display mode B is most suitable for the case where a user values airtime information, and the display mode C is most suitable for the case where a user values genre information.

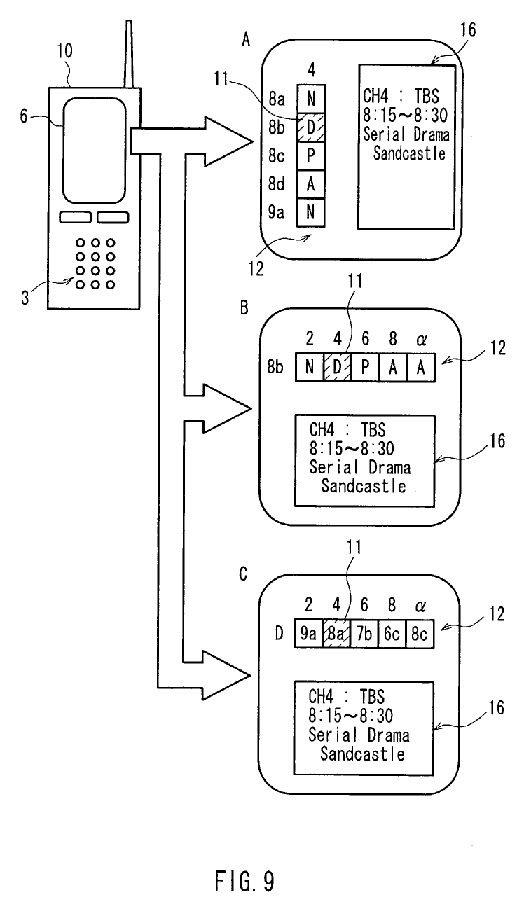

The display example 5 shown in FIG. 9 also is an example in which the program guide table 12 and the detailed information 16 are displayed on a single screen, and the size of the matrix cells is not fixed, as in the display example 4. Also, in the display example 5, there are three display modes A, B and C. The display mode A is most suitable for the case where a user values channel information, the display mode B is most suitable for the case where a user values airtime information, and the display mode C is most suitable for the case where a user values genre information. However, unlike the display example 4, only one row or column of the matrix cells in the program guide table 12 is displayed in the display example 5, thereby improving a display speed for scrolling the program guide table 12. Consequently, when the user values any of the channel, the airtime and the genre, he/she can search the program faster than in the cases of the other display examples.

In the present invention, it should be understood that the program guide matrix could have genre and airtime as the rows and columns, with channel indicated in the individual cells. In addition, although all of the genre, airtime and channel are simplified in the present embodiment, it is also appropriate to store at least one of these as a symbol in the present invention.

The invention may be embodied in other specific forms without departing from the spirit or essential characteristics thereof. The embodiments disclosed in this application are to be considered in all respects as illustrative and not restrictive, the scope of the invention being indicated by the appended claims rather than by the foregoing description, all changes that come within the meaning and range of equivalency of the claims are intended to be embraced therein.

What is claimed is:

1. A portable remote terminal apparatus for receiving a program guide information that includes at least a title information, a genre information, an airtime information and a channel information of a program and displaying a program guide table, the portable remote terminal apparatus comprising:
a receiver portion for receiving the program guide information;
a storing portion for storing symbols that represent in a simplified manner at least one of kinds of a genre, a channel and an airtime of the program;
a detecting portion for detecting the genre information, the airtime information and the channel information of the program from the program guide information;
a constructing portion for selecting the symbols corresponding to the genre, the airtime and the channel of the program included in the genre information, the airtime information and the channel information of the program that have been detected and arranging the symbols that have been selected, thus constructing the program guide table; and
a displaying portion for displaying the program guide table that has been constructed.

2. The portable remote terminal apparatus according to claim 1, further comprising an input portion for accepting an input from a user.

3. The portable remote terminal apparatus according to claim 2, wherein the symbols that represent in a simplified manner the at least one of kinds of the genre, the channel and the airtime of the program are set by the user,
the input portion accepts the input of the symbols that have been set by the user, and
the storing portion stores the symbols that have been input.

4. The portable remote terminal apparatus according to claim 2, wherein the input portion accepts the input of a minimum size for the symbols constituting the program guide table, and
the displaying portion displays the program guide table constituted by the symbols that are at least as large as the minimum size.

5. The portable remote terminal apparatus according to claim 2, wherein the input portion further accepts the input of a program that is selected by the user based on the program guide table,
the detecting portion detects from the program guide information stored in the storing portion the title information, the genre information, the airtime information and the channel information of the program selected by the user, and
the displaying portion displays a title, a genre, an airtime and a channel of the program based on the detected information.

6. The portable remote terminal apparatus according to claim 5, wherein the displaying portion displays the title, the genre, the airtime and the channel of the program and an entirety or a part of the program guide table on a single screen.

7. A method for displaying an electronic program guide, of receiving a program guide information that includes at least a title information, a genre information, an airtime information and a channel information of a program and displaying a program guide table, the method comprising:
(a) setting symbols that represent in a simplified manner at least one of kinds of a genre, a channel and an airtime of the program;
(b) receiving the program guide information;
(c) detecting the genre information, the airtime information and the channel information of the program from the program guide information;
(d) selecting the symbols corresponding to the genre, the airtime and the channel of the program included in the genre information, the airtime information and the channel information of the program that have been detected and arranging the symbols that have been selected, thus constructing the program guide table; and
(e) displaying the program guide table that has been constructed.

8. The method for displaying an electronic program guide according to claim 7, wherein in the (a) setting, a minimum size for the symbols constituting the program guide table is set, and
in the (e) displaying, the program guide table constituted by the symbols that are at least as large as the minimum size is displayed.

9. The method for displaying an electronic program guide according to claim 7, further comprising
(f) selecting at least one program based on the program guide table,
(g) detecting from the program guide information the title information, the genre information, the airtime information and the channel information of the program that has been selected, and
(h) displaying a title, a genre, an airtime and a channel of the program based on the detected information.

10. The method for displaying an electronic program guide according to claim 9, wherein in the (h) displaying, the title, the genre, the airtime and the channel of the program and an entirety or a part of the program guide table are displayed together on a single screen.
